(19) United States
(12) Patent Application Publication
(10) Pub. No.: US 2023/0042421 A1
(43) Pub. Date: Feb. 9, 2023

(54) METHOD FOR PRODUCING A MOTOR VEHICLE RIM FROM ALUMINUM OR AN ALUMINUM ALLOY FOR A WHEEL OF A MOTOR VEHICLE, AND CORRESPONDING MOTOR VEHICLE RIM

(71) Applicant: AUDI AG, Ingolstadt (DE)

(72) Inventors: Jaan Mattes REILING, Sassenberg (DE); Jan GAUGLER, Neckarmühlbach (DE); Marc HUMMEL, Güglingen (DE); Michael KORTE, Ingolstadt (DE)

(73) Assignee: AUDI AG, Ingolstadt (DE)

(21) Appl. No.: 17/788,117

(22) PCT Filed: Dec. 9, 2020
(86) PCT No.: PCT/EP2020/085191

§ 371 Date: Jun. 22, 2022

(30) Foreign Application Priority Data
Jan. 14, 2020 (DE) 10 2020 100 700.0

(51) Int. Cl. B60B 1/08; B60B 21/02; B22D 18/06

(52) U.S. Cl. CPC B60B 1/08; B60B 21/026; B60B 21/023; B22D 18/06; B60B 2360/104; B60B 2310/202

(57) ABSTRACT

A method for producing a motor car rim made of aluminum or an aluminum alloy for a wheel of a motor vehicle. The motor car rim has a rim well delimited on opposite sides by an outer flange and an inner flange, a hub with a center recess and a pitch circle diameter, as well as a rim center connecting the rim well and the hub to one another and engaging the rim well off-center in the longitudinal section. The rim center is formed with several spokes spaced apart from one another in the circumferential direction as relates to a center longitudinal axis of the motor car rim.

### FIELD

The invention relates to a method for producing a motor car rim made of aluminum or an aluminum alloy for a wheel of a motor vehicle, wherein the motor car rim has a rim well delimited on opposite sides by an outer flange and an inner flange, a hub with a center recess and a pitch circle diameter, as well as a rim center connecting the rim well and the hub to one another and engaging the rim well off-center in the longitudinal section, wherein the rim center is formed with several spokes spaced apart from one another in the circumferential direction as relates to a center longitudinal axis of the motor car rim. The invention further relates to a motor car rim.

### BACKGROUND

Publication EP 0 301 472 B1, for example, is known from the prior art. This document describes a production process for light metal casting of wheels for passenger cars, wherein a near-eutectic, refined AlSi alloy is used, which—in addition to Al—contain parts by weight of 9.5% to 12.5% silicon and alloy components such as maximum 0.2% iron, maximum 0.05% manganese, maximum 0.1% titanium, maximum 0.03% copper, maximum 0.05% zinc, as well as other impurities of at most 0.05% each or totaling at most 0.15%, and wherein the wheels are removed from the casting mold after solidification and cooled down. In this case, it is provided that the alloy contains at least 0.05 to at most 0.15% parts by weight magnesium and that the wheels of a temperature—measured at the surface thereof—of at least 380° C. on the inner regions or regions with mass concentrations, such as the hub and the wheel discs, are quenched in water directly after removal from the casting mold.

Furthermore, publication DE 101 20 203 A1 describes a wheel, in particular for a two-wheeled vehicle, preferably for a motorcycle, having a hub, a rim, and spokes extending between the hub and the rim, wherein the wheel is divided vertically and each of the two wheel parts essentially comprises half of the hub, the spokes, and the rim as integral components, wherein the two wheel parts are formed identically at least for the most part and are connected to one another exclusively in the region of the hub and the rim. In this case, it is provided that the spokes are formed intricately in the sense of traditional motorcycle spokes and that the spokes assigned to the wheel parts are spaced apart from one another on the hub-side ends thereof and are directly adjacent one another on the rim-side ends thereof in the connecting region of the wheel parts.

### SUMMARY

The object of the invention is to propose a method for producing a motor car rim made of aluminum or an aluminum alloy for a wheel of a motor vehicle, which method has advantages over known methods of this type, in particular enabling an especially quick and economical production of the motor car rim with especially intricate structures.

This is achieved by means of a method for producing a motor car rim. In this case, it is provided that the motor car rim is produced as one piece and contiguously in a casting mold by vacuum casting of a casting material, wherein, by means of the vacuum casting, at least one of the spokes has a slight wall thickness of at most 15 mm, at least in sections, and/or has a curvature with a slight curvature radius of at most 4 mm, and/or has a demolding surface extending in the axial direction and in the radial direction and/or in the axial direction and in the tangential direction as relates to the center longitudinal axis of the motor car rim, which demolding surface lies completely in an imaginary plane, wherein the plane forms an angle with the center longitudinal axis of more than 0° and at most 4°.

The motor car rim is typically a component of the wheel of the motor vehicle, wherein several wheels are arranged on the motor vehicle, each of which having one such motor car rim. The motor vehicle is in the form of a motor car and, in this respect, has more than two wheels, in particular precisely four wheels. The motor car rim is provided and formed explicitly for use in such a motor vehicle formed as a motor car. The motor car rim is thus not in the form of a generic motor vehicle rim but intended for use in the motor car and formed accordingly.

The motor car rim has the rim well, the rim center, and the hub as essential components. The rim well and the hub are connected to one another via the rim center, wherein at least the rim well, the rim center, and the hub are formed as one piece with one another using uniform material. To this end, the rim well, the rim center, and the hub are formed with one another at the same time, namely during a single production step. Thus, it is not provided to produce the rim well, the rim center, and the hub separately from one another and to attach them to one another subsequently. Instead, the production takes place jointly, namely by vacuum casting of the casting material in the casting mold.

The motor car rim has a center longitudinal axis, which in particular corresponds to a center longitudinal axis of the hub and preferably coincides or at least practically coincides with a subsequent axis of rotation of the wheel. As seen in the axial direction as relates to this center longitudinal axis, the rim well is delimited on opposite sides by the outer flange and the inner flange. In this respect, the outer flange and the inner flange lie on opposite sides of the rim well and enclose a tire mounting region of the motor car rim therebetween, as seen in the longitudinal section as relates to the center longitudinal axis. The tire mounting region is used for mounting a tire, which, together with the motor car rim, forms the wheel. The tire mounting region is delimited inwardly by the rim well in the radial direction and on opposite sides by the outer flange and the inner flange in the axial direction.

As seen in the axial direction or in the longitudinal section, the entire motor car rim is especially preferably delimited in a first direction by the outer flange and in a second direction by the inner flange such that the outer flange and the inner flange define an overall extension of the motor car rim in the axial direction, corresponding to a width of the motor car rim. When the wheel is mounted on the motor vehicle, it is rotatably mounted on a wheel carrier via a wheel bearing. After the wheel is mounted on the motor vehicle, the outer flange lies on a side of the motor car rim facing away from the wheel carrier and the inner flange lies on a side of the motor car rim facing the wheel carrier.

The outer flange and the inner flange are in the form of a radial projection extending from the rim well, which radial projection extends outwardly from the rim well in the radial direction, as relates in turn to the center longitudinal axis of the motor car rim. Of course, the outer flange and the inner flange are also formed as one piece having the same material as the rest of the motor car rim, in particular the rim well, the rim center, and the hub. In this respect, they are formed at the same time therewith during the vacuum casting.

The hub has the center recess and the pitch circle diameter. The center recess is a central recess for accommodating a wheel hub of the motor vehicle, to which recess the wheel is attached when mounted on the motor vehicle. The wheel hub is rotatably mounted on the wheel carrier via the wheel bearing. The pitch circle diameter consists of several drilled holes arranged along an imaginary circle, each drilled hole serving to accommodate an attachment means, with the aid of which the motor car rim is attached to the wheel hub. The attachment means is present, for example, in the form of a screw, a bolt, or the like.

The rim well and the hub are connected to one another via the rim center. Thus, the rim center is positioned between the rim well and the hub as seen in the radial direction as relates to the center longitudinal axis. It extends from the hub up to the rim well as seen in the radial direction. The rim center has several spokes, which are arranged or formed spaced apart from one another in the circumferential direction. Such an embodiment of the rim center in particular is used to reduce the weight of the motor car rim but also to achieve improved damping.

The rim center in this regard is not solid and continuous in the circumferential direction but rather is composed of several spokes which are arranged spaced apart from one another in the circumferential direction. Preferably, each of the several spokes extend from the hub up to the rim well in the radial direction, thus connecting the hub and the rim well to one another. For example, at least three spokes, at least four spokes, at least five spokes, or at least six spokes are provided. For example, at least 10, at least 14, or at least 18 spokes are implemented. Preferably, there are at most 30 spokes or at most 20 spokes. For example, each of the spokes extends at most 30° or less, preferably at most 15°, or at most 10° in the circumferential direction.

It can be provided that the spokes have a constant extension in the circumferential direction, i.e., from the rim well up to the hub. However, there can also be a branching of at least one of the spokes or several or each of the spokes such that the respective spoke is thus divided into several sub-spokes. For example, the spoke initially extends from the hub outwardly in the radial direction and is then divided into several sub-spokes at a point of division, which sub-spokes continue on from one another, in particular in the circumferential direction. After the point of division, the sub-spokes thus extend spaced apart from one another up to the rim well and engage said rim well spaced apart from one another. It can be provided that a center longitudinal axis of at least one of the spokes, in particular the center longitudinal axis of several or of all the spokes, intersects the central longitudinal axis of the motor car rim or is positioned perpendicular thereto. This provides an especially optimum introduction of force from the rim center or from the spokes into the hub.

The rim center engages the rim well off-center as seen in the axial direction or in the longitudinal section. This means that the rim center merges into the rim well away from a center point of the rim well in the axial direction. Preferably, the rim center engages with a distance from the center point of the rim well in the axial direction which amounts to at least 10%, at least 20%, at least 30%, at least 40%, or more in relation to a total extension of the rim well in the axial direction. For example, the rim center merges into the rim well at the end thereof as seen in the axial direction. In this case, the rim center opens into the rim well overlapping with the outer flange or the inner flange, preferably the former, as seen in the longitudinal section. Due to the rim center engaging the rim well off-center, not only is there a force acting upon the rim center in the radial direction but also a bending moment acting in the axial direction or in an imaginary plane including the center longitudinal axis of the motor car rim, after the wheel is mounted on the motor vehicle. Because of this, previously it was necessary to form the rim center to be accordingly solid using a lot of material.

As seen in the longitudinal section, the rim well preferably has a larger extension in the axial direction than the rim center and the hub. In particular, the axial extension of the rim well is greater than the axial extension of the hub, which, in turn, is greater than the axial extension of the rim center. For example, the axial extension of the hub is at most 50%, at most 40%, at most 30%, at most 25%, or at most 20% in relation to the axial extension of the rim well. The axial extension of the rim center, for example, is at most 25%, at most 20%, at most 15%, at most 10%, or at most 5% in relation to the axial extension of the rim well. Due to the rim center engaging the rims off-center, the aforementioned dimensions provide a mount for the wheel hub, which mount is engaged by the rim well and/or a brake disc attached to the wheel, wherein the wheel hub and/or the brake disc is present in this mount after the wheel is mounted on the motor vehicle.

The motor car rim consists of the casting material, namely the aluminum or—preferably—the aluminum alloy contiguously and with uniform material. This material is processed using vacuum casting. In the vacuum casting process, the casting mold is used, by means of which the motor car rim and thus at least the rim well, including the outer flange and the inner flange, form the rim center and the hub. The center recess, which can also be designated as the wheel hub mount, is preferably at least partially formed during the vacuum casting.

The vacuum casting is characterized in that the casting mold is at least partially evacuated before and/or during incorporation of the casting material into the casting mold. This means that the casting mold is subjected to a vacuum before and/or during the incorporation of the casting material. The vacuum in this case should be understood as a pressure which is less than an incorporation pressure at which the casting material is incorporated into the casting mold and/or an ambient pressure in an outer environment of the casting mold. For example, the vacuum amounts to at most 50%, at most 25%, at most 10%, or at most 5% as relates to the outer pressure. For example, the residual pressure is between 50 mbar and 200 mbar. The residual pressure should be understood as the absolute pressure in the casting mold.

The casting mold is evacuated, for example, by means of a vacuum source, which is placed in fluid connection with the casting mold for this purpose. In particular, the casting mold is already evacuated before incorporation of the casting material. For example, the casting material is incorporated, or particularly only incorporated, once a particular vacuum or residual pressure is reached in the casting mold. Additionally or alternatively, it can be provided to evacuate the casting mold during incorporation of the casting material, i.e., to maintain the fluid connection between the vacuum source and the casting mold during incorporation of the casting material into the casting mold and to continue to operate the vacuum source for evacuating the casting mold. Especially intricate structures of the motor car rim can hereby be produced.

For example, it is provided to seal the casting mold initially by means of at least one seal, for example by means of a sealing gasket, particularly a silicone sealing gasket. Subsequently, the casting material is dispensed into a casting chamber which is fluidically connected to the casting mold. To this end, the casting chamber is at least temporarily fluidically connected to a crucible, in which the melted casting material is stored. The casting mold is then subjected to the vacuum and the casting material situated in the casting chamber pushes into the casting mold, in particular by means of a pressurized piston. Preferably, the fluid connection between the casting chamber and the crucible exists at the same time, in particular continues to exist. This means that the casting chamber is evacuated also while the casting material is incorporated.

The spokes of the rim center are formed with the vacuum casting or during the vacuum casting. The spokes, which are produced by means of the vacuum casting, are characterized by an especially slight wall thickness or a curvature with an especially slight curvature radius and/or by the presence of the demolding surface. The wall thickness is to be understood as the thickness of the wall of the motor car rim or of the spokes at least at one point. Especially preferably, the slight wall thickness represents the greatest wall thickness of the spokes. Additionally or alternatively, the slight wall thickness can obviously also be used for further regions of the motor car rim. For example, the slight wall thickness is present, for example, at the rim well, the outer flange, the inner flange, and/or the hub.

Accordingly, the slight wall thickness can be the greatest wall thickness of the outer flange, the greatest wall thickness of the inner flange, the greatest wall thickness of the rim well, and/or the greatest wall thickness of the hub.

The slight wall thickness amounts to at most 15 mm, at most 10 mm, at most 7.5 mm, or at most 5 mm, but is preferably less. Thus, it is, for example, at most 4 mm, at most 3 mm, at most 2 mm, or at most 1.5 mm In turn, the slight wall thickness is especially preferably at least 1.5 mm or at least 2 mm In other words, the slight wall thickness amounts to, for example, at least 1.5 mm and at most 5 mm, at least 1.5 mm and at most 4 mm, at least 1.5 mm and at most 3 mm, at least 1.5 mm and at most 2 mm, or approximately or precisely 1.5 mm However, it can also be at least 2 mm and at most 5 mm, at least 2 mm and at most 4 mm, at least 2 mm and at most 3 mm, or precisely 2 mm

In addition to or as an alternative to the slight wall thickness, the curvature is present with the slight curvature radius. The curvature is a curvature of an outer surface or of an outer circumferential surface of one of the spokes. The outer surface in this regard delimits a wall of the spokes outwardly. The curvature can be present at any point on the respective spoke. The curvature is in particular a transition curvature between two surfaces of the respective spoke, which are angled with respect to one another and are present, for example, as planar surfaces—as seen in the section.

The curvature preferably extends over an angle of at least 30°, at least 45°, at least 60°, or at least 90°. The curvature has the slight curvature radius, which is at most 4 mm, but preferably smaller. For example, the slight curvature radius corresponds, for example, to a curvature radius of at most 3 mm, at most 2 mm, at most 1.5 mm, or at most 1 mm in this regard. Preferably, the curvature radii are at most 2 mm or less. In turn, the curvature radius can additionally be at least 0.25 mm, at least 0.5 mm, or at least 0.75 mm

In addition or as an alternative to the slight wall thickness and/or the curvature with the slight curvature radius, the spokes can have the demolding surface. The demolding surface should be understood as a flat surface which rests directly against the casting mold during the vacuum casting and along which the motor car rim is removed from the casting mold after the vacuum casting. The demolding surface has an extension at least in the axial direction and in the radial direction and/or—additionally or alternatively—in the axial direction and in the tangential direction, as relates to the center longitudinal axis of the motor car rim in each case. In any case, the demolding surface thus has an extension in two directions perpendicular to one another, and thus lies completely in the imaginary plane in this regard.

The motor car rim is removed from the mold in the same direction. For example, a part of the casting mold is displaced in the direction of the center longitudinal axis, i.e., in the axial direction, after the vacuum casting, in order to open the casting mold and remove the motor car rim from the casting mold. This means that, during the vacuum casting, a casting mold surface, which rests against the demolding surface thereby forming said surface, of the casting mold is displaced along the center longitudinal axis after the vacuum casting. In a conventional process for producing a motor car rim, a demolding angle, i.e., an angle between the demolding surface and the center longitudinal axis, must be at least 5° in order to properly ensure demolding.

However, a significantly smaller angle can be implemented based on the formation of the motor car rim in one piece and contiguously due to the vacuum casting of aluminum or the aluminum alloy. In this respect, the angle between the demolding surface or between the plane completely containing the demolding surface and the center longitudinal axis amounts to between infinitesimally more than 0° and 4°, these values being included respectively. Thus, it can be provided that the demolding surface extends practically parallel to the center longitudinal axis such that a practically parallel displacement of the casting mold surface and the demolding surface occurs during demolding. The angle of 0° should be understood to mean that the plane and the center longitudinal axis lie within one another or extend parallel to one another. The angle, for example, amounts to at least 0.5°, at least 1°, or at least 1.5° . However, an angle of at most 4° is provided. For example, the angle amounts to at most 3°, at most 2.0°, at most 1.5°, at most 1.0°, or at most 0.5°. In this case, the smaller angles are preferably at most 2.0° and less.

The described procedure with the production of the motor car rim enables a simple, quick, and economical formation of the motor car rim, which simultaneously has an extraordinarily intricate structure, particularly of the spokes. The quick production is primarily achieved by means of the vacuum casting, in which there is significantly faster filling of the casting mold than with gravity die casting or low-pressure casting which is normally used to produce motor car rims. As a whole, the pace during production of the motor car rim can be increased significantly by the vacuum casting such that a greater quantity of motor car rims can be produced within the same time span. The solidification time for pressure casting is also significantly shorter than that for gravity die casting.

One refinement of the invention provides that at least one of the spokes is produced with a first wall thickness of more than 5 mm, particularly at least 7.5 mm or at least 10 mm, in sections and with a second wall thickness corresponding to the slight wall thickness in sections. The second wall thickness preferably amounts to at least 0.5 mm, at least 1 mm, or at least 2 mm and at most 5 mm, preferably at most 3 mm, at most 2.5 mm, or at most 2 mm The corresponding spoke thus does not have the slight wall thickness consistently throughout but instead is composed of several parts, of which some have the first wall thickness and others have the second wall thickness.

In this case, the first wall thickness is very generally greater than the second wall thickness, for example by a factor of at least 1.5, at least 2.0, or at least 2.5. Of course, the wall thicknesses can be used with only one of the spokes. Preferably however, each of the spokes has partially the first wall thickness and partially the second wall thickness. This results in an especially high load-carrying capacity of the motor car rim with an extraordinarily intricate design at the same time.

One refinement of the invention provides that at least one of the spokes is formed, through the vacuum casting, with a support wall having the greater, first wall thickness and at least one ornamental wall having the lesser, second wall thickness. Especially preferably, each of the spokes is embodied as described such that thus each of the spokes has at least one such support wall and at least one such ornamental wall. The support wall and ornamental wall differ, for example, with respect to the load-carrying capacity thereof in the radial direction. Preferably, the support wall or the several support walls represent more than 50% of the load-carrying capacity of the respective spoke, especially preferably at least 60%, at least 70%, or at least 75%. The load-carrying capacity is to be understood as the strength of the respective spoke in the radial direction between the hub and the rim well.

The ornamental wall or the ornamental walls of the respective spoke only contribute to the load-carrying capacity to a lesser extent and supplement the aforementioned load-carrying capacity of the at least one support wall at 100%. Preferably, the support wall has the first wall thickness throughout. Likewise, it can be provided that the ornamental wall has the second wall thickness throughout. The support wall and the ornamental wall are connected to one another at least at points, but preferably throughout. For example, both the at least one support wall as well as the at least one ornamental wall extend particularly parallel to one another, from the hub to the rim well in the radial direction respectively. The provision of both the support wall and the ornamental wall enables a sufficient amount of load-carrying capacity of the motor car rim with a simultaneously intricate appearance.

One refinement of the invention provides that the support wall and the ornamental wall are formed at an angle with respect to one another. The support wall and the ornamental wall are at an angle to one another which is greater than 0° and less than 180°, namely as seen in the cross-section as relates to a center longitudinal axis of the respective spoke. As seen in the cross-section, the support wall has its greatest extension in a first direction and the ornamental wall has its greatest extension in a second direction, wherein the first direction and the second direction are at an angle with respect to one another. For example, the ornamental wall originates from the support wall or vice versa. It is preferable, at least in the cross-section, that the support wall has the first wall thickness throughout and the ornamental wall has the second wall thickness throughout. This results in a complex structure of the spokes, which leads to a good visual impression of the motor car rim.

One refinement of the invention provides that at least one of the spokes has several bars, which have the slight wall thickness and/or are arranged parallel to one another respectively or merge into one another via the curvature. Obviously, several of the spokes or even all of the spokes are preferably embodied in this manner The bars lie particularly in the cross-section as relates to a center longitudinal axis of the respective spoke. For example, one of the bars of the support wall can correspond to another of the bars of the ornamental wall. The bars can also be present in addition to the support wall and the ornamental wall, however. The bars each have the slight wall thickness, namely throughout. Alternatively, the wall thickness of the several bars can also be less than the slight wall thickness, in particular if the ornamental wall is present in addition to the bars.

The bars can extend parallel to one another, namely apart from one another in parallel, as seen in the cross-section. This should particularly be understood to mean that the center longitudinal axes of the bars are arranged parallel to one another. It is not necessary for surfaces of the bars, particularly surfaces of the bars facing one another, to extend parallel to one another. For example, the bars are connected to one another via the support wall or the ornamental wall. Of course, it is not necessary for both the support wall and the ornamental wall to be present if the bars are present. Instead, it is sufficient if only the support wall or the ornamental wall is a component of the respective spoke. As an alternative to the parallel arrangement of the bars, the bars can also extend from one another. In this case, they are at an angle with respect to one another and merge into one another via the curvature, as seen in the cross-section. In this regard, the bars are connected to one another via the curvature with the slight curvature radius. This results, in turn, in a good visual impression of the motor car rim.

One refinement of the invention provides that the bars are formed originating from a wall formed by the support wall or the ornamental wall. Thus, the bars merge into the wall on one side and extend from the wall on the other side. For example, the bars and/or center longitudinal axes of the bars in this case extend parallel to one another such that a rake-like structure is formed, as seen in the cross-section as relates to the center longitudinal axis of the respective spoke. For example, there are at least three, at least four, or at least five bars. Several bars are used in order to implement an especially intricate overall impression of the motor car rim.

One refinement of the invention provides that the bars are formed having a free end. The free end is understood to mean an end of the bar which is arranged apart from the other elements of the same spoke, as seen in the cross-section. In any case, the free end is attached to the hub on one side and/or to the rim well on the other side or is formed as one piece therewith, as seen in the axial direction as relates to the central longitudinal axis of the respective spokes. The free end of each of the bars lies on the particular side of the respective bar which is facing away from the wall from which the bar extends. The previously mentioned intricate overall impression of the motor car rim is hereby implemented especially effectively.

One refinement of the invention provides that the bars are formed spaced apart from one another originating from the wall such that the bars and the wall jointly form a U-shape enclosing a cavity. Preferably, the bars in this case extend parallel to one another in addition and each have a free end, namely on the side of the respective bar facing away from the wall. The parallel extension of the bars, in turn, preferably means a parallel extension of the center longitudinal axes of the bars. Two of the bars and the wall are arranged respectively in a U-shape as relates to each other; in particular, the bars are vertically positioned on the wall and have a continuously straight extension, as seen in the cross-section. The cavity is formed between the bars and the wall, which are U-shaped as relates to one another, as seen in the section. The cavity is thus delimited—as seen in the section—by the bars on opposite sides and by the wall on a further side. The cavity is open on a fourth side. Especially preferably, the respective spoke has several such cavities, with at least three bars being present for the formation thereof. Especially preferably, at least three or at least four cavities and a corresponding number of bars are implemented. This results in an especially good visual impression of the motor car rim.

One refinement of the invention provides that the cavity is formed having a depth which corresponds at least to the wall thickness of the wall. The cavity, which is delimited by the bars and the wall jointly, as seen in the cross-section, is thus not embodied as a flat recess but more so as a significantly discernible cavity. To this end, it has a depth which corresponds at least to the wall thickness of the wall from which the bars originate, but is preferably greater. For example, the depth of the cavity is greater than the wall thickness of the wall by a factor of at least 1.5, at least 2.0, at least 2.5, or more, wherein the depth of the cavity and the wall thickness of the wall are present in the same direction, as seen in the cross-section.

The invention further relates to a motor car rim made of aluminum or an aluminum alloy for a wheel of a motor vehicle, particularly produced according to the embodiments within the scope of this description, wherein the motor car rim has a rim well delimited on opposite sides by an outer flange and an inner flange, a hub with a center recess and a pitch circle diameter, as well as a rim center connecting the rim well and the hub to one another and engaging the rim well off-center in the longitudinal section, wherein the rim center has several spokes spaced apart from one another in the circumferential direction as relates to a center longitudinal axis of the motor car rim.

In this case, it is provided that the motor car rim is produced as one piece and contiguously in a casting mold by vacuum casting of a casting material, wherein, by means of the vacuum casting, at least one of the spokes has a slight wall thickness of at most 15 mm, at least in sections, and/or has a curvature with a slight curvature radius of at most 3 mm, particularly of at most 2 mm or at most 1 mm, and/or has a demolding surface extending in the axial direction and in the radial direction and/or in the axial direction and in the tangential direction as relates to a center longitudinal axis of the motor car rim, which demolding surface lies completely in an imaginary plane, wherein the plane forms an angle with the center longitudinal axis of more than 0° and at most 4°.

The advantages of such an embodiment of the motor car rim and/or such a procedure during the production thereof has already been addressed. Both the motor car rim as well as the method for the production thereof can be refined according to the statements within the scope of this description, to the extent that reference is made thereto.

### BRIEF DESCRIPTION OF THE FIGURES

The invention is explained in more detail in the following by means of exemplary embodiments, without limiting the invention. The following is shown:

FIG. 1 a schematic longitudinal sectional view through a motor car rim along a center longitudinal axis of the motor car rim;

FIG. 2 a sectional view through a spoke of a rim center of the motor car rim in a first embodiment;

FIG. 3 a schematic sectional view of the spoke in a second embodiment;

FIG. 4 a schematic sectional view of the spoke in a third embodiment;

FIG. 5 a schematic sectional view of the spoke in a fourth embodiment; and

FIG. 6 a schematic sectional view of the spoke in a fifth embodiment.

### DETAILED DESCRIPTION

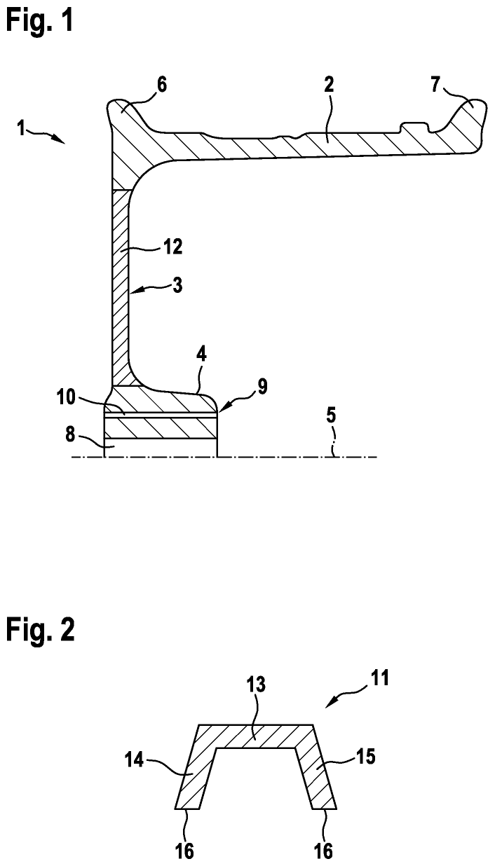

FIG. 1 shows a schematic longitudinal sectional view of a motor car rim 1 for a wheel of a motor vehicle. The motor car rim 1 has a rim well 2, a rim center 3, and a hub 4 as essential components. The motor car rim 1 is shown in the longitudinal section as relates to a center longitudinal axis 5 of the motor car rim 1. The rim well 2 is delimited in the axial direction by an outer flange 6 on one side and by an inner flange 7 on the other side, which extend outwardly starting from the rim well 2 in the radial direction as relates to the central longitudinal axis 5. It should be noted in a supplementary manner that the axial extension of the rim well 2 extends up to a respective outer-side end of the outer flange 6 or the inner flange 7. The axial extension of the rim well 2 thus includes the axial extensions of the outer flange 6 and of the inner flange 7.

The rim well 2 and the hub 4 are connected to one another via the rim center 3. Thus, the rim center 3 engages both the rim well 2 as well as the hub 4 and extends from the hub 4 up to the rim well 2. The hub 4 has a center recess 8, which is situated centrally in the hub 4 as relates to the central longitudinal axis 5 and which fully engages the hub in the axial direction. In addition, the hub 4 has a pitch circle diameter 9 with several drilled holes 10, each of which serve for accommodating an attachment means, by means of which the motor car rim 1 is or can be attached to a wheel hub of the motor vehicle.

In the exemplary embodiment shown here, the rim center 3 has several spokes 11 (not shown), which are arranged spaced apart from one another in the circumferential direction. Each of the spokes 11 extends from the hub 4 up to the rim well 2. There is an intermediate spoke region between the spokes 11 in the circumferential direction, which intermediate spoke region is delimited inwardly by the hub 4 in the radial direction and delimited outwardly by the rim well 2 in the radial direction, in the circumferential direction of the spokes 11.

In the embodiment shown, an intermediate spoke element 12, which fills out the intermediate spoke region, for example, completely or merely partially, is formed in this intermediate spoke region. At a minimum, the intermediate spoke element 12 has a slight wall thickness of at most 5 mm In particular in order to implement this, the motor car rim 1 is produced as one piece and contiguously in a casting mold by means of vacuum casting of a casting material. Aluminum or an aluminum alloy is used as the casting material. However, the intermediate spoke element 12 is completely optional.

FIG. 2 shows one of the spokes 11 in a schematic cross-sectional view along a center longitudinal axis of the spoke 11. The center longitudinal axis in this case extends from the rim well 2 up to the hub 4. Preferably, it intersects the center longitudinal axis 5 of the motor car rim 1; in particular, it is perpendicular thereto. As seen in the cross-section, the spoke 11 consists essentially of bars 13, 14, and 15, wherein bars 14 and 15 are connected to one another solely via bar 13. Bars 14 and 15 each have a free end 16 on the side thereof facing away from bar 13. Bars 13, 14, and 15 are each embodied with the slight wall thickness of at most 15 mm, at least in sections or even completely. For example, bar 13 is embodied with a wall thickness of at most 5 mm and bars 14 and 15 with a wall thickness of more than 5 mm, particularly more than 10 mm.

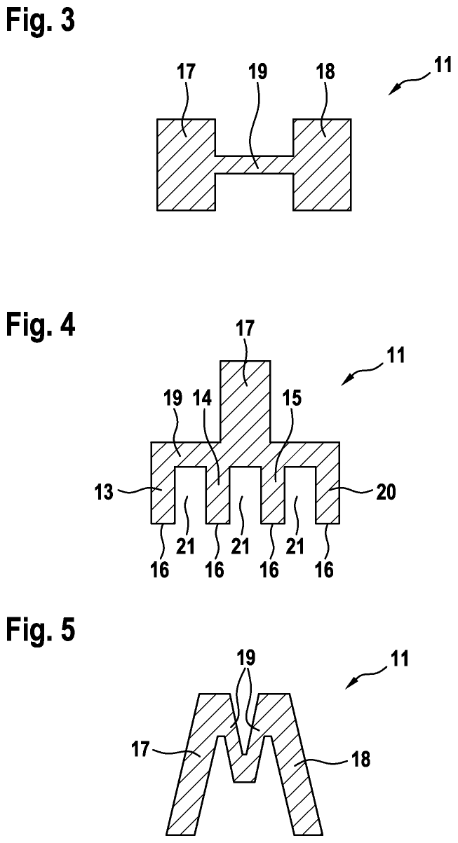

FIG. 3 shows a second embodiment of the spoke 11, in the cross-section here. The spoke 11 consists of two support walls 17 and 18, which are connected to one another via an ornamental wall 19. As seen in the cross-section, support walls 17 and 18 are arranged parallel or at least approximately parallel to one another, while the ornamental wall 19 is perpendicular to both support wall 17 and support wall 18 or the corresponding center longitudinal axes. The ornamental wall engages support walls 17 and 18 in the center, as seen in the cross-section. As a whole, the spoke 11 consequently has the shape of an I-beam in the cross-section. It is clearly obvious that support walls 17 and 18 have a greater wall thickness than ornamental wall 19. For example, the wall thickness of the ornamental wall 19 corresponds to the slight wall thickness of at most 5 mm, while the wall thickness of support walls 17 and 18 is greater than the wall thickness of the ornamental wall 19, for example, by a factor of at least 1.5, at least two, at least three, at least four, or at least five.

FIG. 4 shows a third embodiment of the spoke 11 in the cross-section. In this case, the spoke 11 has a support wall 17, an ornamental wall 19 perpendicular thereto, as well as bars 13, 14, 15, and 20. The support wall 17, in turn, has a greater wall thickness than the ornamental wall 19. Bars 13, 14, 15, and 20 are embodied, for example, with the same wall thickness as the ornamental wall 19. Alternatively, the wall thickness thereof can also be smaller. As seen in the cross-section, bars 13, 14, 15, and 20 extend in the same direction as the support wall 17. Thus, they also are perpendicular to the ornamental wall 19, but on the side of the ornamental wall 19 opposite the support wall 17. Bars 13, 14, 15, and 20 extend from the ornamental wall 19 parallel or at least approximately parallel to one another, so that they each have a free end 16. Two of bars 13, 14, 15, and 20 as well as the ornamental wall 19 jointly delimit a cavity 21, wherein such cavities 21 are formed in the exemplary embodiment 3 shown here.

FIG. 5 shows a cross-sectional view of the spoke 11 in a fourth embodiment. This embodiment has support walls 17 and 18 as well as two ornamental walls 19. Support walls 17 and 18 are connected to one another only via the two ornamental walls 19, wherein the two ornamental walls 19 are angled with respect to one another and preferably form an acute angle between each other. In other words, the ornamental walls 19 are arranged in a V shape as relates to one another. Support wall 17 and 18 can extend parallel to one another or—as shown here—can be angled as relates to one another or have angled central longitudinal axes as relates to one another, as seen in the cross-section. As a whole, support walls 17 and 18 as well as the ornamental walls 19 are in the shape of an M, as seen in the cross-section.

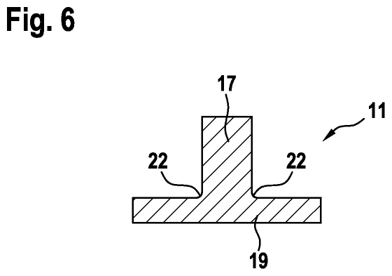

FIG. 6 shows a fourth embodiment of the spoke 11 in a schematic cross-sectional view. The spoke 11 has the support wall 17 as well as the ornamental wall 19, which are angled as relates to one another, particularly which are perpendicular to one another. The support wall and the ornamental wall 19 merge with one another forming a curvature 22, which has a slight curvature radius of at most 4 mm

The described embodiment of the motor car rim 1 realizes an extremely intricate appearance and simultaneously ensures an economical and fast production of the motor car rim 1 due to the production of the motor car rim 1 using vacuum casting. In addition, excellent strength values are achieved by means of vacuum casting of the aluminum or of the aluminum alloy.

### LIST OF REFERENCE NUMERALS:

1 Motor car rim
2 Rim well
3 Rim center
4 Hub
5 Center longitudinal axis
6 Outer flange
7 Inner flange
8 Center recess
9 Pitch circle diameter
10 Drilled hole
11 Spoke
12 Intermediate spoke element
13 Bar
14 Bar
15 Bar
16 End
17 Support wall
18 Support wall
19 Ornamental wall
20 Bar
21 Cavity
22 Curvature

1-10. (canceled)

11. A method for producing a motor car rim made of aluminum or an aluminum alloy for a wheel of a motor vehicle, wherein the motor car rim has a rim well delimited on opposite sides by an outer flange and an inner flange, a hub with a center recess and a pitch circle diameter, as well as a rim center connecting the rim well and the hub to one another and engaging the rim well off-center in the longitudinal section, wherein the rim center is formed with several spokes spaced apart from one another in the circumferential direction as relates to a center longitudinal axis of the motor car rim, wherein the motor car rim is produced as one piece and contiguously in a casting mold by vacuum casting of a casting material, wherein, by means of the vacuum casting, at least one of the spokes has a slight wall thickness of at most 15 mm, at least in sections, and/or
a curvature with a slight curvature radius of at most 4 mm, and/or
a demolding surface extending in the axial direction and in the radial direction and/or in the axial direction and in the tangential direction as relates to the center longitudinal axis of the motor car rim, which demolding surface lies completely in an imaginary plane, wherein the plane forms an angle with the center longitudinal axis of more than 0° and at most 4°.

12. The method according to claim 11, wherein at least one of the spokes is produced with a first wall thickness of more than 5 mm and with a second wall thickness corresponding to the slight wall thickness in sections.

13. The method according to claim 11, wherein at least one of the spokes is formed, through the vacuum casting, with a support wall having the greater, first wall thickness and at least one ornamental wall having the lesser, second wall thickness.

14. The method according to claim 11, wherein the support wall and the ornamental wall are formed at an angle with respect to one another.

15. The method according to claim 11, wherein at least one of the spokes has several bars, which have the slight wall thickness and/or are arranged parallel to one another respectively or merge into one another via the curvature.

16. The method according to claim 11, wherein the bars are formed originating from a wall formed by the support wall or the ornamental wall.

17. The method according to claim 11, wherein the bars are formed having a free end.

18. The method according to claim 11, wherein the bars are formed spaced apart from one another originating from the wall such that the bars and the wall jointly form a U-shape enclosing a cavity.

19. The method according to claim 11, wherein the cavity is formed having a depth which corresponds at least to the wall thickness of the wall.

20. A motor car rim made of aluminum or an aluminum alloy for a wheel of a motor vehicle, comprising: a rim well delimited on opposite sides by an outer flange and an inner flange, a hub with a center recess and a pitch circle diameter, as well as a rim center connecting the rim well and the hub to one another and engaging the rim well Off-center in the longitudinal section, wherein the rim center has several spokes spaced apart from one another in the circumferential direction as relates to a center longitudinal axis of the motor car rim, wherein the motor car rim is produced as one piece and contiguously in a casting mold by vacuum casting of a casting material, wherein, by means of the vacuum casting, at least one of the spokes has
a slight wall thickness of at most 15 mm, at least in sections, and/or
a curvature with a slight curvature radius of at most 4 mm, and/or
a demolding surface extending in the axial direction and in the radial direction and/or in the axial direction and in the tangential direction as relates to the center longitudinal axis of the motor car rim, which demolding surface lies completely in an imaginary plane, wherein the plane forms an angle with the center longitudinal axis of more than 0° and at most 4°.

21. The method according to claim 12, wherein at least one of the spokes is formed, through the vacuum casting, with a support wall having the greater, first wall thickness and at least one ornamental wall having the lesser, second wall thickness.

22. The method according to claim 12, wherein the support wall and the ornamental wall are formed at an angle with respect to one another.

23. The method according to claim 13, wherein the support wall and the ornamental wall are formed at an angle with respect to one another.

24. The method according to claim 12, wherein at least one of the spokes has several bars, which have the slight wall thickness and/or are arranged parallel to one another respectively or merge into one another via the curvature.

25. The method according to claim 13, wherein at least one of the spokes has several bars, which have the slight wall thickness and/or are arranged parallel to one another respectively or merge into one another via the curvature.

26. The method according to claim 14, wherein at least one of the spokes has several bars, which have the slight wall thickness and/or are arranged parallel to one another respectively or merge into one another via the curvature.

27. The method according to claim 12, wherein the bars are formed originating from a wall formed by the support wall or the ornamental wall.

28. The method according to claim 13, wherein the bars are formed originating from a wall formed by the support wall or the ornamental wall.

29. The method according to claim 14, wherein the bars are formed originating from a wall formed by the support wall or the ornamental wall.

30. The method according to claim 15, wherein the bars are formed originating from a wall formed by the support wall or the ornamental wall.
